(19) United States
(12) Patent Application Publication
(10) Pub. No.: US 2015/0289715 A1
(43) Pub. Date: Oct. 15, 2015

(54) Oven Toaster

(71) Applicant: Albert William Hartkorn, Miami Beach, FL (US)

(72) Inventor: Albert William Hartkorn, Miami Beach, FL (US)

(21) Appl. No.: 13/999,954

(22) Filed: Apr. 10, 2014

(51) Int. Cl. A47J 33/00

(52) U.S. Cl. CPC A47J 33/00; A47J 2202/00

(57) ABSTRACT

The Oven Toaster is a foldable metal box that is used for warming food with a standard toaster or warming or baking food over a camp fire or barbequing food over a propane flame or propane grill or side burner. It folds into a small briefcase sized box that you can carry anywhere for easy transportation.

There is no federally sponsored or research or development associated with this application. There is no joint research agreement associated with this application.

### BACKGROUND OF THE INVENTION

(1) Field of the Invention

The Oven Toaster is used for warming foods and cooking foods in different ways.

(2) Description of the art including information disclosed under 37 CFR 1.97 & 1.98

The art described in the drawings of the design and utility function illustrate the unique ability of the Oven Toaster and we found no other patents that were similar enough to pose a problem with this application.

### BRIEF SUMMARY OF THE INVENTION

The Oven Toaster is a unique device that can be used as a food warmer with a standard toaster placed inside the unit and can be used as an oven or barbeque using a campfire coals as a heat source and by using propane.

### BRIEF DESCRIPTION OF THE SEVERAL VIEWS OF THE DRAWINGS

There are 8 drawings in total that describe and illustrate the design and function of the Oven Toaster. The broken lines used for the propane hose are for illustration purposes only and are not a part of this application.

FIG. 1: is the front side angle view of the invention.

FIG. 2: is the rear side angle view of the invention.

FIG. 3: is the front view of the invention.

FIG. 4: is the front interior view of the invention. (The broken lines are not a part if this application)

FIG. 5: is the top view of the interior. (The broken lines are not a part of this application)

FIG. 6: is the top view of the invention in a semi folded position.

FIG. 7: is the top view of the invention in a complete folded position.

FIG. 8: is the overall view of the invention folded into the carrying case.

### DETAILED DESCRIPTION OF THE PREFERRED EMBODIMENT

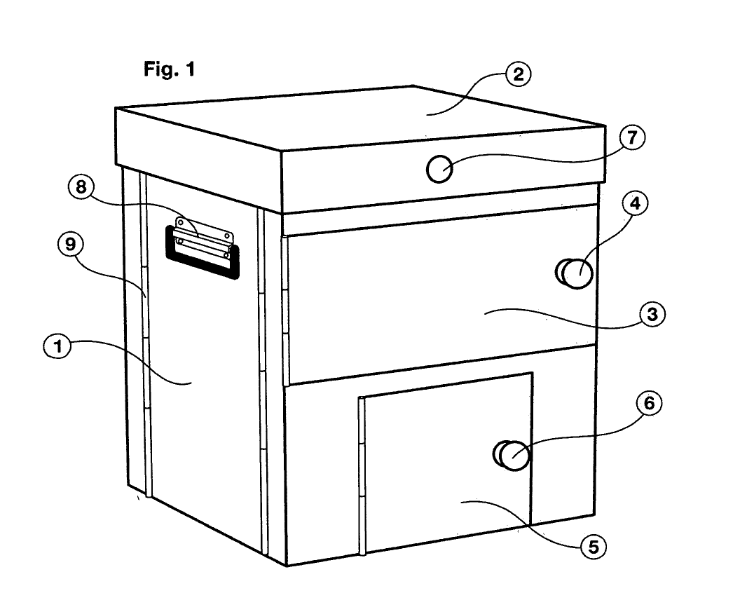

FIG. 1: In this front side angle view illustration #1 is the main body with #2 the top piece with #3 the top oven door with #4 the top front door knob with #5 the bottom access door with #6 the bottom access door knob with #7 the inside temperature thermostat with #8 the side handle with #9 the folding hinge.

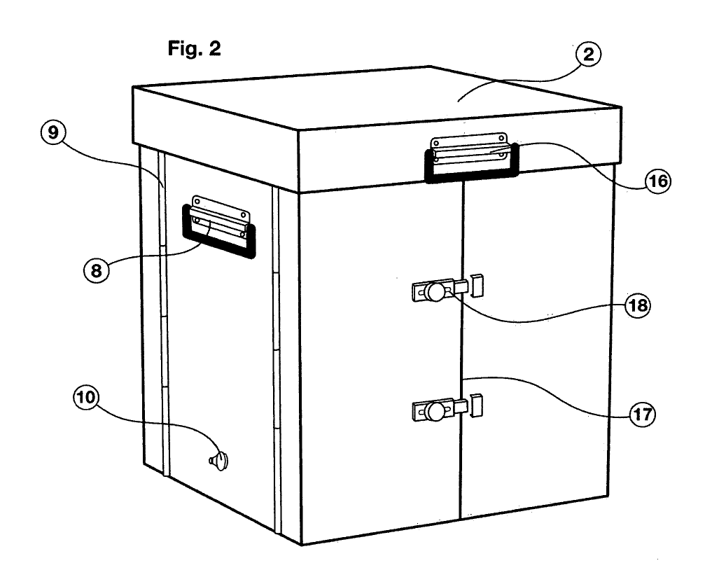

FIG. 2: In this rear side angle view illustration #2 is the top piece with #8 the side handle with #9 the folding hinge with #10 the hose access and cover with #16 the top piece carrying handle with #17 the separation joint in the rear walls with #18 the sliding lock assembly for the rear walls.

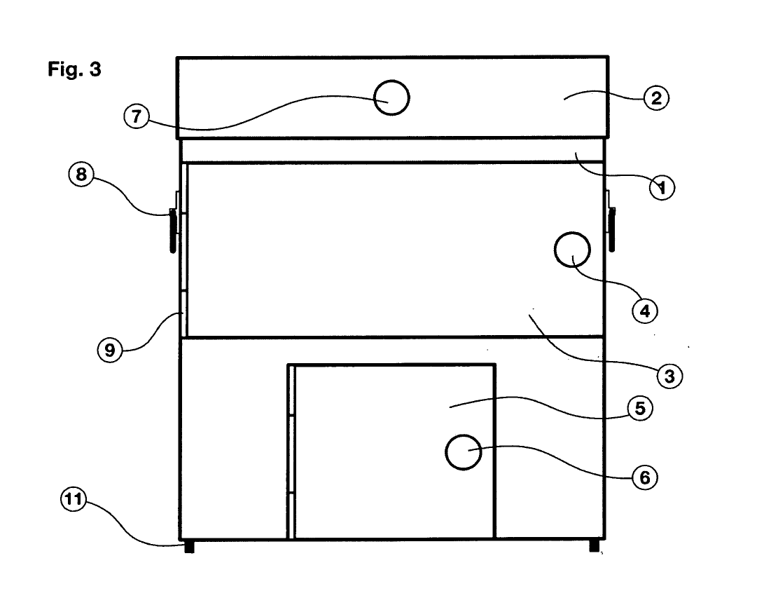

FIG. 3: In this front view illustration #1 is the main body with #2 the top piece with #3 the top oven door with #4 the top front door knob with #5 the bottom access door with #6 the bottom access door knob with #7 the inside temperature thermostat with #8 the side handle with #9 the folding hinge with #11 the leg for the unit.

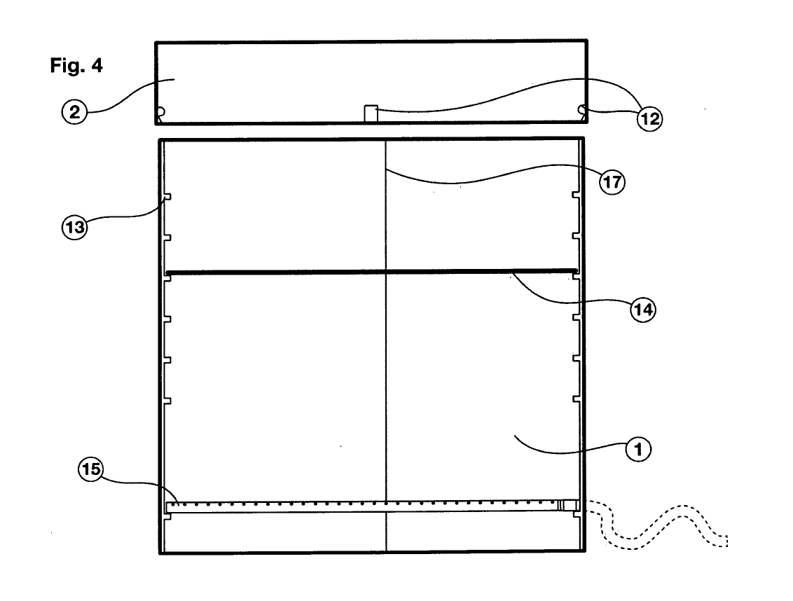

FIG. 4: In this front interior view illustration #1 is the main body with #2 the top piece with #12 the spring loaded clips that hold the top piece to the main body with #13 the notched slots that hold the grill grid in place at different levels with #14 the grill grid with #15 the propane tube with #17 the rear walls separation fold. (The broken lines are depicting a propane hose and it is not a part of this application)

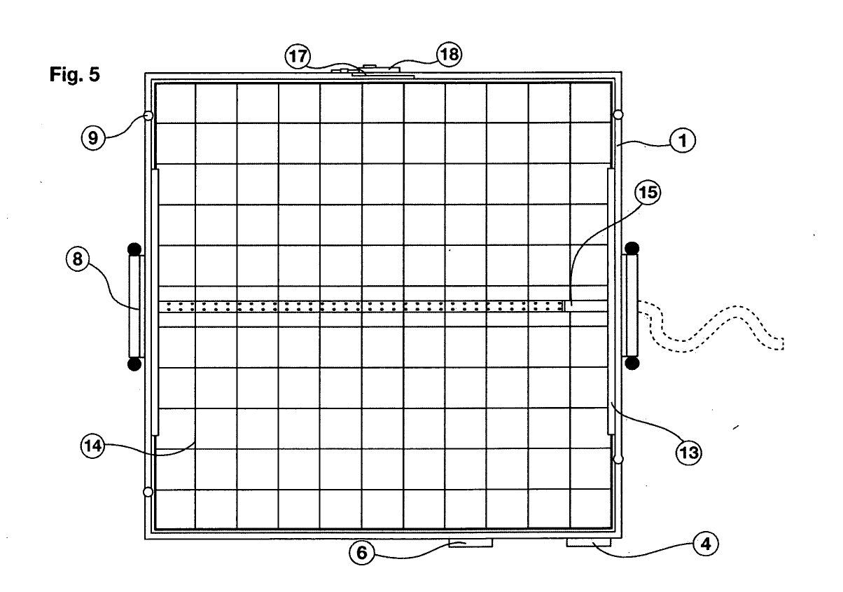

FIG. 5: In this top interior view illustration #1 is the main body with #4 the top oven door knob with #6 the bottom access door knob with #8 the side handle with #9 the folding hinge with #13 the notched slots that hold the grill grid in place with different levels with #14 the grid piece of the grill with #15 the propane tube with #17 the rear walls separation fold with #18 the sliding lock assembly. (The broken lines are depicting a propane hose and it is not a part of this application)

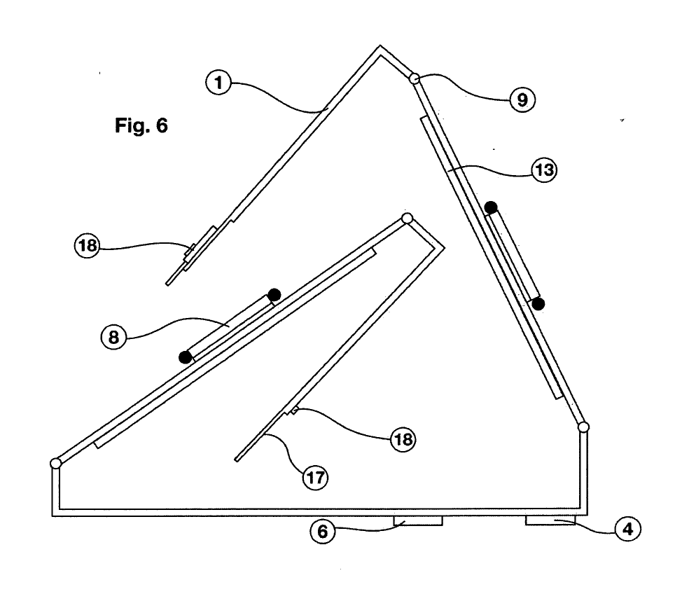

FIG. 6: In this top view semi folded position illustration #1 is the main body with #4 the top oven door knob with #6 the bottom access door knob with #8 the side handle with #9 the folding hinge with #13 the notched slots that hold the grill grid in place with different levels with #17 the rear walls separation fold with #18 the sliding lock assembly.

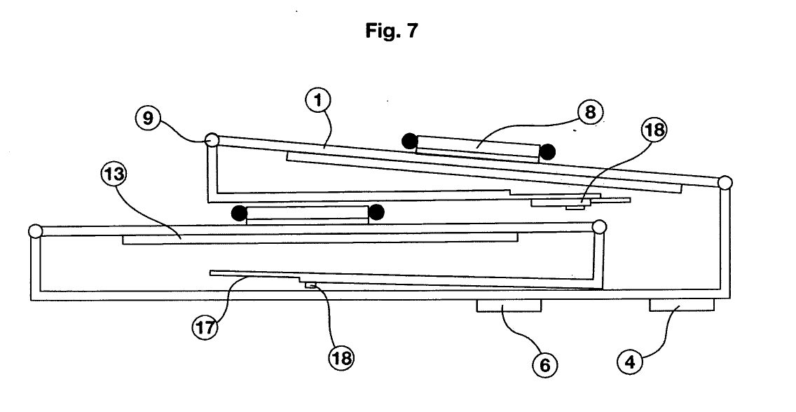

FIG. 7: In this top view completely folded position illustration #1 is the main body with #4 the top oven door knob with #6 the bottom access door knob with #8 the side handle with #9 the folding hinge with #13 the notched slots that hold the grill grid in place with different levels with #17 the rear walls separation fold with #18 the sliding lock assembly.

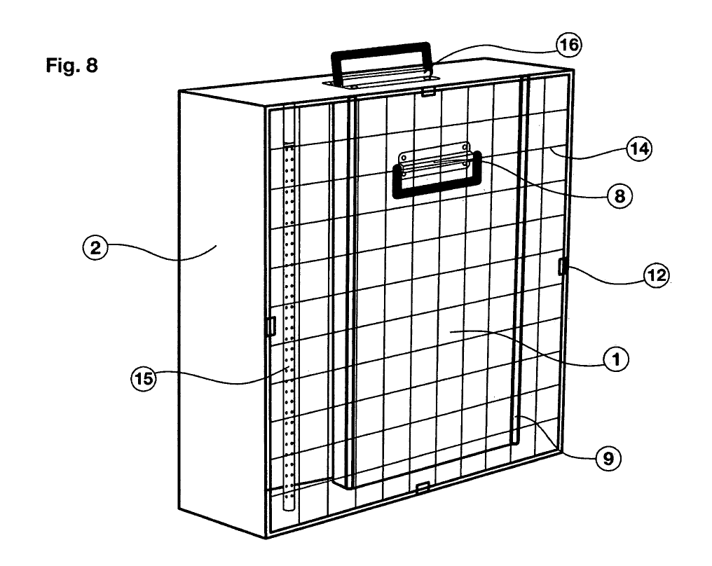

FIG. 8: In this overall view of the carrying case assembly illustration #1 is the main body with #2 the top piece with #8 the side handle with #9 the folding hinge with #12 the spring loaded clips that hold the top in place to the main body and also hold the grill grid in place in the carrying case assembly with #14 the Grill grid piece with #15 the propane tube with #16 the top piece handle for the carrying case.

### DETAILED DESCRIPTION OF THE INVENTION

The Oven Toaster is a multi-purpose appliance that is made of metal and is used to warm up food or it can be used as an oven as well. The first ability is you can set the unit on a counter top and place a standard toaster inside the unit. A bottom access door is there so that you can adjust the toaster so that it will disperse the heat inside the unit and warm up many more things than a regular toaster oven. Hence the name Oven Toaster. The unit can have more than one grill grid so that you can warm even more things. A prototype has been made and this really works well with a regular toaster.

The second ability is that you can use the unit for camping. When you a camp fire burning you can place the unit on the side of the fire over the hot coals and it will bring the heat level up very high. High enough to cook food such as a whole chicken, meatloaf and anything else you can think of. Because it does not have a bottom portion the unit stays much cleaner than other similar products.

The third ability is that you can use a propane tank to hook to the unit through the opening and cover on the side of the unit and use the propane tube with the unit which is removable and cook food as a barbeque or as an oven. This allows you to use it anywhere for any purpose.

The fourth ability is that you can place the unit on a propane barbeque for instance either on the main grill portion or on the side burner portion and you can cook more food separately to increase the number of food items or to speed up the process. This is great for picnics and such.

The unit has a removable top part that has four spring loaded clips that hold the top in place to the main body which also hold the grill grid part in place when the unit is folded into a completely closed position. The top acts as the main portion of a carrying case with a handle attached to it.

The main body has hinges built in to be able to fold the unit into a very thin unit to be placed inside the top portion and by using the grill grid and the spring loaded clips it becomes a very slim unit and it can be stored easily taking up very little space and can be carried easily and all the parts fit into the case assembly and they will not be lost in transition.

The unit has hinges located a distance from the corners to allow the thickness of the side walls and rear walls to be folded into position. The unit has Notched slots that hold the grill grid in place and allow numerous heights so that you can barbeque or bake food. In all the unit is very useful for many purposes and can fit into almost any situation.

What is claimed is:

1. The Oven Toaster invention has a main body comprising of:
a metal body with four walls and no bottom portion that conducts heat from a standard toaster or camp fire coals or propane flame;
a hinge located a short distance from the four corners of the unit equal to the total thickness of all four walls to be folded into a flat position;
a hinge that is on the inside of the unit to allow the unit to fold to the inside of the unit;
a sliding lock assembly that locks the rear walls into a locked position so that the rear walls will not fold and to unlock to allow the rear walls to fold;
a handle on each side of the unit located in the center of the side;
a multiple of notched slits on the inside of the unit positioned from the front side to the rear side of the unit placed in numerous positions of height to adjust the grill grid to different heights inside the unit;
a hole located in the bottom side portion of the unit with a cover that slides over the hole to seal the hole when it is in baking mode;
a hole located in the bottom side portion of the unit that allows the propane tube positioned inside the unit and held within the hole and allows the propane hose to connect to the propane tube.

2. A top portion of the invention comprising of:
a thermostat located in the front center top portion;
a handle on the top portion that acts as a carrying handle;
a lip surrounding the top portion with enough depth to allow the folded walls of the unit to fit inside the lip of the top portion;
a spring loaded clip that holds the top portion to the main body during use and to hold the grill grid into place when the unit is in its fully folded position inside the top portion lip.
